(19) United States
(12) Patent Application Publication
(10) Pub. No.: US 2005/0016568 A1
(43) Pub. Date: Jan. 27, 2005

(54) Apparatus and method for cleaning of semiconductor device manufacturing equipment

(75) Inventors: Hee-Hwan Choe, Incheon-si (KR); In-Ho Song, Seoul (KR); Sung-Chul Kang, Yongin-si (KR); Sang-Gab Kim, Seoul (KR)

Correspondence Address: David W. Heid;MacPherson Kwok Chen & Heid LLP, Suite 226, 1762 Technology Drive, San Jose, CA, 95110, US

(73) Assignee: SAMSUNG ELECTRONICS CO., LTD., Suwon-si (KR)

(21) Appl. No.: 10/870,309

(22) Filed: Jun. 16, 2004

(30) Foreign Application Priority Data
Jun. 16, 2003 (KR) 2003-38710

(51) Int. Cl. B08B 3/00

(52) U.S. Cl. 134/100.1; 134/22.1; 156/345.43

(57) ABSTRACT

A cleaning apparatus and method are provided for the removal of contaminants from semiconductor processing equipment. An electrode to generate a cleaning plasma is provided within a processing chamber and a guide system is capable of moving the electrode over contaminated areas. Advantageously, the present invention saves cleaning time compared with a conventional cleaning method that requires the opening and cleaning of the chamber and also allows for increasing the interval between regular cleanings.

### BACKGROUND

(a) Field of the Invention

The present invention relates to semiconductor processing, and in particular relates to an apparatus and method for cleaning of plasma-type manufacturing apparatus.

(b) Description of Related Art

A manufacturing method for a semiconductor device requires several apparatuses and equipment for thin film deposition, such as sputter deposition equipment or chemical vapor deposition (CVD) equipment, dry and wet etching equipment for patterning thin films, and photolithography equipment for forming photoresist patterns used as etching masks for patterning thin films.

This type of equipment is disassembled and cleaned regularly in order to prevent disorder and to improve productivity.

In particular, a dry etching apparatus significantly requires regular cleaning since it is easily contaminated by polymers of photoresist blown from semiconductor substrates that are combined with etching gases.

For example, particles attached to a plasma chamber not only serve as a source of contamination but also change the condition of plasma required for dry etching, thereby deteriorating the reliability of semiconductor devices formed in semiconductor substrates.

### SUMMARY

The present invention provides an apparatus and method for cleaning and removing contaminants from equipment used in manufacturing semiconductor devices.

In accordance with one embodiment, a cleaning apparatus is provided, comprising an electrode to generate cleaning plasma in a processing chamber, and a guide system operably coupled to the electrode, the guide system capable of moving the electrode within the processing chamber.

In accordance with another embodiment, an apparatus for manufacturing a semiconductor device is provided, comprising a processing chamber including a first electrode, a cleaning apparatus within the processing chamber, the cleaning apparatus including a second electrode to generate cleaning plasma within the processing chamber in conjunction with the first electrode, and a guide system operably coupled to the second electrode, the guide system capable of moving the second electrode within the processing chamber.

In accordance wit yet another embodiment, a method of cleaning a semiconductor processing apparatus is provided, comprising providing a processing chamber including a first electrode, and providing a cleaning apparatus within the processing chamber, the cleaning apparatus including a second electrode and a guide system operably coupled to the second electrode. The method further includes flowing a cleaning gas into the processing chamber, generating a cleaning plasma from the cleaning gas using the first and second electrodes, and applying the cleaning plasma to a contaminant on an interior surface of the processing chamber.

Advantageously, the present invention saves cleaning time compared with a conventional cleaning method that requires the opening and cleaning of the chamber and also allows for increasing the interval between regular cleanings.

### BRIEF DESCRIPTION OF THE DRAWINGS

The present invention will become more apparent by describing embodiments thereof in detail with reference to the accompanying drawings in which:

FIG. 1 is a schematic sectional view of a dry etching device according to an embodiment of the present invention;

FIG. 2 is a plan view of a cleaning unit in the dry etching device shown in FIG. 1 in accordance with an embodiment of the present invention;

FIGS. 3 and 4 illustrate a schematic sectional view and a perspective view of a cleaning unit in accordance with an embodiment of the present invention;

FIG. 5 is a schematic sectional view of a dry etching device according to another embodiment of the present invention; and

FIG. 6 is a plan view of a cleaning unit in the dry etching device shown in FIG. 5 in accordance with an embodiment of the present invention.

### DETAILED DESCRIPTION

The present invention now will be described more fully hereinafter with reference to the accompanying drawings, in which preferred embodiments of the invention are shown. The present invention may, however, be embodied in many different forms and should not be construed as limited to the embodiments set forth herein.

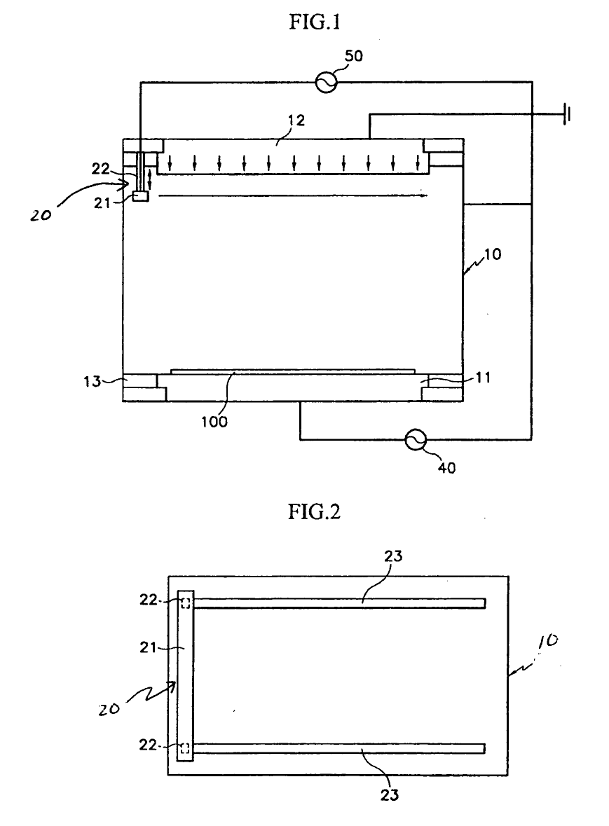

Apparatus for manufacturing a semiconductor device according to embodiments of the present invention will be described with reference to the accompanying drawings. In one example, a dry etching device according to an embodiment of the present invention will be described in detail with reference to FIGS. 1 and 2.

FIG. 1 is a schematic sectional view of a dry etching device according to an embodiment of the present invention, and FIG. 2 is a plan view of a cleaning unit in the dry etching device shown in FIG. 1.

Referring now to FIGS. 1 and 2, a dry etching device according to an embodiment of the present invention includes an etching chamber 10 containing plasma, lower and upper electrodes 11 and 12 for generating plasma, and a cleaning unit 20 for cleaning the interior of the dry etching device.

The chamber 10 contains the lower and the upper electrodes 11 and 12 and the cleaning unit 20. A gas inlet (not shown) for inflow of reactant gases is also provided at the chamber 10.

The lower and the upper electrodes 11 and 12 are disposed on a bottom and a top surface of the chamber 10, respectively, such that they face each other and are spaced apart from each other. The lower electrode 11 is electrically connected to a first power supply 40, which supplies power to the lower electrode 11 for generating “etching plasma” using inflow gases, while the upper electrode 12 is grounded.

The lower electrode 11 is proximate an exhaust 13 for discharging reactant gases and air from the chamber 10. A workpiece, such as a semiconductor substrate 100 for semiconductor devices or display devices, is mounted on lower electrode 11.

The upper electrode 12 has a plurality of through holes (not shown) through which reactant gases from the gate inlet pass to reach a reaction area disposed between the lower electrode 11 and the upper electrode 12. The through holes are arranged such that the reactant gases are uniformly distributed in the reaction area. For example, the concentration or the size of the through holes in the upper electrode 12 becomes larger as it goes away from the exhaust 13. This prevents the reactant gases from gathering near the exhaust 13 and makes the gases uniformly reach the surface of the substrate 100, thereby performing uniform etching.

The cleaning unit 20 includes a cleaning electrode 21 electrically connected to a second power supply 50 which supplies power to the cleaning electrode 21 for generating “cleaning plasma” in cooperation with the upper electrode 12, by using cleaning gases from the gas inlet. An electrode guide 23 guides the cleaning electrode 21 to move in a horizontal direction, and a plurality of electrode supporters 22 support the cleaning electrode 21 and guide the cleaning electrode 21 to move in a vertical direction. It will be apparent that in other embodiments, the cleaning unit may utilize a single electrode guide 23 and a single electrode supporter 22 for moving the cleaning electrode in horizontal and vertical directions, respectively.

Now, the operation of the dry etching device shown in FIGS. 1 and 2 are described in detail.

Reactant gases containing at least one component flow into the chamber 10 through the gas inlet. The gases pass through the through holes in the upper electrode 12 and diffuse in a reaction area disposed between the upper electrode 12 and the lower electrode 11. As described above, the size or the concentration of the through holes varies depending on the distance from the exhaust 13 in order to diffuse the reactant gases uniformly.

The lower electrode 11 is supplied with bias voltage from the first power supply 40 to generate a vertical electric field and a horizontal magnetic field in the chamber 10.

Free electrons are discharged from the powered electrode 11 and accelerated by obtaining kinetic energy from the electromagnetic field. The accelerated electrons pass through the reactant gases in the reaction area and impact the reactant gases to transfer their energy to the reactant gases. The reactant gases are then ionized and the reactant gas ions are also accelerated by the electromagnetic field to pass through the reactant gases to transfer their energy to the reactant gases. This process makes a plasma containing positive ions, negative ions, radicals, and atomic groups in the reaction area, and the reactive species in the plasma chemically react to or physically strike a thin film of a wafer or the substrate 100 to etch the thin film.

At this time, some of the reactant gases are attached to the upper electrode 12 or the walls of the chamber 10 to become a source of contamination, and the contaminating particles are removed by using the cleaning unit 20.

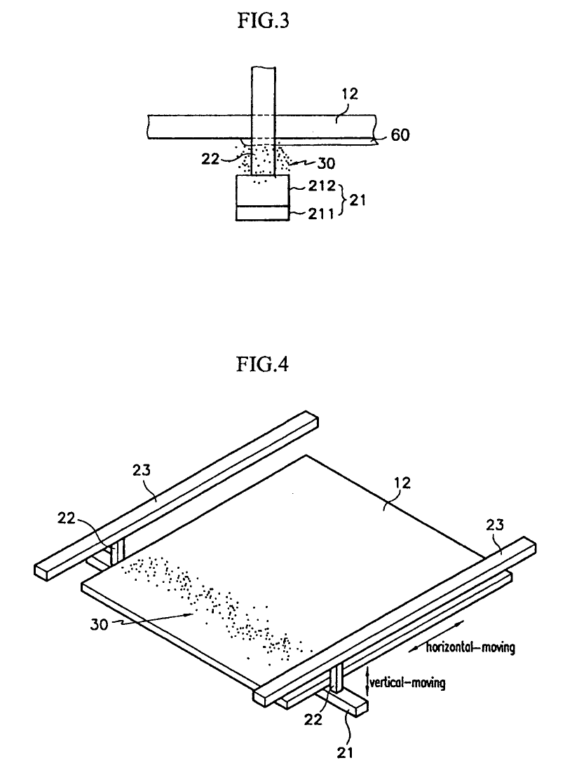

Now, a cleaning unit of the dry etching device shown in FIGS. 1 and 2 and a method of cleaning the dry etching device according to an embodiment of the present invention is described in detail with reference to FIGS. 3 and 4.

FIGS. 3 and 4 illustrate a cleaning unit of the dry etching device shown in FIGS. 1 and 2 according to an embodiment of the present invention.

Referring now to FIGS. 3 and 4, a cleaning electrode 21 includes a conductor 212 and a protector 211 for covering the conductor 212. The protector 211 is preferably made of ceramic.

First, contamination material 60 deposited on walls of the chamber 10 and surfaces of the electrodes 11 and 12 is detected by electrical or optical detection. The conductor 212 of the cleaning electrode 21 is supplied with DC or AC bias voltage from the second power supply 50. The cleaning electrode 21 is moved in the vertical direction using the electrode supporters 22 until the cleaning electrode 21 is disposed under the upper electrode 12, and then the cleaning electrode 21 is moved in the horizontal direction using the electrode guide 23.

Cleaning gases such as fluorine based gases, chlorine based gases, and inactive gases are flowed into the chamber 10 through the through holes of the upper electrode 12, and a cleaning plasma 30 containing positive ions, negative ions, radicals, and atomic groups of the cleaning gases is generated between the upper electrode 12 and the cleaning electrode 21.

The reactive species of the cleaning gases are subjected to physical and chemical reaction with the contamination 60 to remove the contamination 60 from the walls of the chamber 10 and the upper electrode 12, after which the contamination 60 is exhausted out of chamber 10 through the exhaust 13. Polymers of the contamination 60 are mainly removed by fluorine ions or radicals, while metal particles are mainly removed by chlorine ions or radicals, and inactive gases.

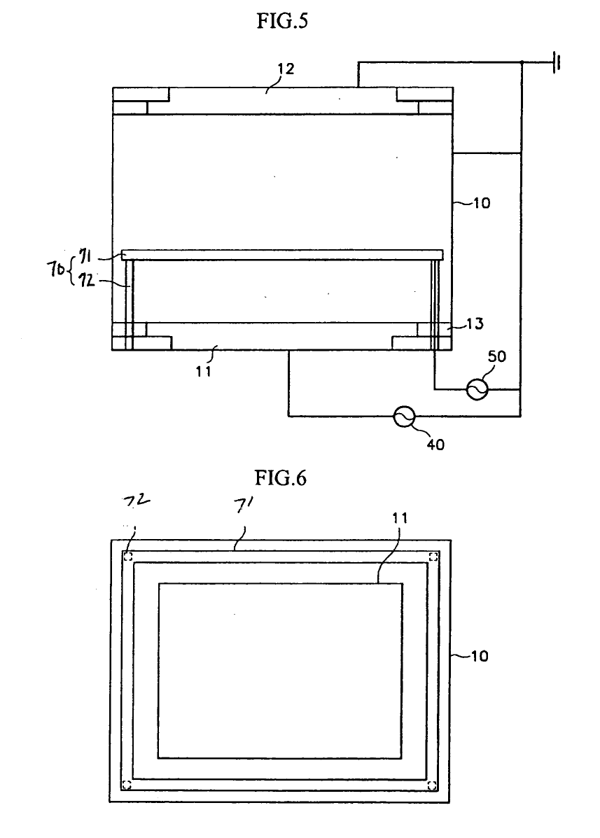

A dry etching device according to another embodiment of the present invention is described in detail with reference to FIGS. 5 and 6.

FIG. 5 is a schematic sectional view of a dry etching device according to an embodiment of the present invention, and FIG. 6 is a plan view of a cleaning unit in the dry etching device shown in FIG. 5.

Referring now to FIGS. 5 and 6, a configuration of a dry etching device according to this embodiment is substantially the same as FIGS. 1 and 2. That is, the dry etching device includes a chamber 10, lower and upper electrodes 11 and 12, and a cleaning unit 70.

However, the cleaning unit 70 of the dry etching device according to this embodiment has a different configuration from that shown in FIGS. 1 and 2. The cleaning unit 70 includes a ring-shaped cleaning electrode 71 and a plurality of electrode supporters 72 supporting the cleaning electrode 71 and guiding the cleaning electrode 71 to move in a vertical direction.

The walls of the chamber 10 are grounded and the cleaning electrode 71 is electrically connected to a power supply 50, which supplies power to cleaning electrode 71 for generating cleaning plasma. The powered cleaning electrode 71 and the grounded chamber walls generate a cleaning plasma.

When the increase of a contamination material 60 (FIG. 3) deposited on walls of the chamber 10 and surfaces of the electrodes 11 and 12 is detected by electrical or optical detection, the cleaning electrode 71 is supplied with DC or AC bias voltage from the second power supply 50. The cleaning electrode 71 is moved in the vertical direction using the electrode supporters 72 and the cleaning electrode 71 generates a cleaning plasma between the cleaning electrode 71 and the chamber walls. The reactive species of the cleaning gases are subjected to physical and chemical reaction with the contamination 60 to remove the contamination 60 from the walls of the chamber 10 or the electrodes 11 and 12, and they are exhausted out of chamber 10 by the exhaust 13.

The cleaning electrode 71 moves upward and downward to remove the particles on the entire surface of the chamber walls.

The cleaning units according to these embodiments can be applied to reactive ion etch equipment, plasma enhanced (PE) dry etching device, and inductively coupled plasma (ICP) dry etching equipment.

The cleaning units according to these embodiments can be also applied to sputter equipment for depositing a conductive film and chemical vapor deposition (CVD) equipment for depositing a thin film by chemical reactions. Like the above-described dry etching device, such a sputter equipment or CVD equipment may include a grounded electrode and a powered electrode connected to a power supply for generating a cleaning plasma. The sputter equipment may further include an additional electrode for supporting a sputtering target to be deposited on a semiconductor device or a panel for a display device and electrically connected to a power supply. The CVD equipment may further include a supply for reactant gases. Here, the grounded electrode may be a separate electrode or walls of the chamber 10.

The present invention advantageously provides a cleaning electrode for generating a plasma to clean the inside of a chamber to save cleaning time compared with a conventional cleaning method that requires the opening and cleaning of the chamber and also allows for increasing the interval between regular cleanings.

While the present invention has been described in detail with reference to the preferred embodiments, those skilled in the art will appreciate that various modifications and substitutions can be made thereto without departing from the spirit and scope of the present invention as set forth in the appended claims.

1. A cleaning apparatus for semiconductor device manufacturing equipment, comprising:
an electrode to generate cleaning plasma in a processing chamber; and
a guide system operably coupled to the electrode, the guide system capable of moving the electrode within the processing chamber.

2. The apparatus of claim 1, wherein the electrode is shaped to have a length substantially similar to the depth of the processing chamber.

3. The apparatus of claim 2, wherein the guide system includes a vertical guide member operably coupled to the electrode, and a horizontal guide member operably coupled to the electrode.

4. The apparatus of claim 1, wherein the electrode is shaped to have a length and a width substantially similar to the depth and width of the processing chamber.

5. The apparatus of claim 4, wherein the guide system includes a vertical guide member operably coupled to the electrode.

6. The apparatus of claim 1, wherein the electrode includes a conductive layer and a protective layer covering the conductive layer.

7. The apparatus of claim 6, wherein the protective layer is comprised of ceramic.

8. The apparatus of claim 1, wherein the electrode generates a cleaning plasma in conjunction with an electrode of the processing chamber.

9. The apparatus of claim 8, further comprising a power supply operably coupled to the electrode to generate cleaning plasma and the electrode of the processing chamber.

10. An apparatus for manufacturing a semiconductor device, comprising:
a processing chamber including a first electrode;
a cleaning apparatus within the processing chamber, the cleaning apparatus including a second electrode to generate cleaning plasma within the processing chamber in conjunction with the first electrode; and
a guide system operably coupled to the second electrode, the guide system capable of moving the second electrode within the processing chamber.

11. The apparatus of claim 10, wherein the processing chamber is selected from the group consisting of a dry etch chamber, a sputter deposition chamber, and a chemical vapor deposition chamber.

12. The apparatus of claim 10, wherein the second electrode is shaped to have a length substantially similar to the depth of the processing chamber.

13. The apparatus of claim 12, wherein the guide system includes a vertical guide member operably coupled to the second electrode, and a horizontal guide member operably coupled to the second electrode.

14. The apparatus of claim 10, wherein the second electrode is shaped to have a length and a width substantially similar to the depth and width of the processing chamber.

15. The apparatus of claim 14, wherein the guide system includes a vertical guide member operably coupled to the second electrode.

16. The apparatus of claim 10, wherein the second electrode includes a conductive layer and a protective layer covering the conductive layer.

17. The apparatus of claim 16, wherein the protective layer is comprised of ceramic.

18. The apparatus of claim 10, further comprising a power supply operably coupled to the first and second electrodes.

19. The apparatus of claim 10, further comprising a third electrode for mounting a substrate thereon.

20. The apparatus of claim 19, further comprising a power supply operably coupled to the third electrode.

21. The apparatus of claim 10, further comprising an exhaust for removing contaminants out of the processing chamber.

22. A method of cleaning a semiconductor processing apparatus, comprising:
providing a processing chamber including a first electrode;
providing a cleaning apparatus within the processing chamber, the cleaning apparatus including a second electrode and a guide system operably coupled to the second electrode;
flowing a cleaning gas into the processing chamber;
generating a cleaning plasma from the cleaning gas using the first and second electrodes; and
applying the cleaning plasma to a contaminant on an interior surface of the processing chamber.

23. The method of claim 22, further comprising moving the second electrode within the processing chamber using the guide system.

24. The method of claim 23, further comprising moving the second electrode in a vertical direction using the guide system.

25. The method of claim 23, further comprising moving the second electrode in a horizontal direction using the guide system.
